(19) United States
(12) Patent Application Publication
(10) Pub. No.: US 2016/0179392 A1
(43) Pub. Date: Jun. 23, 2016

(54) NON-VOLATILE MEMORY DEVICE

(71) Applicant: Panasonic Intellectual Property Management Co., Ltd., Osaka (JP)

(72) Inventor: Masato SUTO, Osaka (JP)

(21) Appl. No.: 15/061,382

(22) Filed: Mar. 4, 2016

Related U.S. Application Data
(63) Continuation of application No. PCT/JP2015/000435, filed on Feb. 2, 2015.

(30) Foreign Application Priority Data
Mar. 28, 2014 (JP) 2014-068196
Dec. 8, 2014 (JP) 2014-247986

(51) Int. Cl. G06F 3/06

(52) U.S. Cl. CPC G06F 3/0604; G06F 3/0632; G06F 3/0679; G06F 3/0655

(57) ABSTRACT

In a non-volatile memory device, a non-volatile memory has: a user data area, writing/reading data into/from the user data area being possible according to an access by an external device; and an access information storing area for storing access information indicating the access. A memory controller is connected to the non-volatile memory, and includes an access information writing unit that stores the access information in the access information storing area on an occurrence of the access. The access information includes: an access type including at least writing of data, reading of data, deletion of data, and initialization of the memory controller; a data address in the user data area, and a data size. An access information writing unit stores the access information in the access information storing area so that an order of a process executed by the memory controller according to the access can be obtained.

### BACKGROUND

1. Technical Field

The present disclosure relates to a method of obtaining access information with respect to a non-volatile memory device.

2. Description of the Related Art

Unexamined Japanese Patent Publication No. 2006-31106 discloses a memory card that is capable of obtaining a history of accesses to the memory card by a host device. This memory card has a user data area and an access count storing area, and can record the number of times the user data area was accessed by a host device on a specific block by block basis. This makes it possible to obtain information indicating a history of accesses to individual content stored in the user data area. It is also possible to identify unnecessary contents that are not accessed from information indicating the obtained history of accesses. Accordingly, the unnecessary contents can be deleted to increase available storage space of the memory card.

### SUMMARY

In one general aspect, the techniques disclosed here feature a non-volatile memory device that is connectable to an external device, and that comprises a non-volatile memory, and a memory controller. The non-volatile memory has: a user data area, writing data into and reading the data from the user data area being possible according to an access by the external device; and an access information storing area for storing access information indicating the access. The memory controller is connected to the non-volatile memory, and includes an access information writing unit that stores the access information into the access information storing area on an occurrence of the access. The access information includes: an access type including at least writing of data, reading of the data, erasing of the data, and initialization of the memory controller; an address of the data in the user data area; and a size of the data. The access information writing unit stores the access information in the access information storing area so that an order of a process executed by the memory controller according to the access can be obtained.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

It should be noted that general or specific embodiments may be implemented as a system, a method, an integrated circuit, a computer program, a storage medium, or any selective combination thereof.

The non-volatile memory device in accordance with the present disclosure is effective to accurately recognize a history of accesses to a non-volatile memory.

### BRIEF DESCRIPTION OF DRAWINGS

FIG. 1 is a schematic diagram illustrating a configuration of a non-volatile memory device in accordance with a first exemplary embodiment;

FIG. 2 is a schematic diagram illustrating an internal configuration of a non-volatile memory;

FIG. 3 is a schematic diagram illustrating an internal configuration of an access information storing area;

FIG. 4A is a schematic diagram illustrating an internal configuration of a system information storing area;

FIG. 4B is a schematic diagram illustrating an internal configuration of a system information storing area;

FIG. 5 is a flowchart for explaining an initializing process of the non-volatile memory device;

FIG. 6 is a flowchart for explaining a user data writing process of the non-volatile memory device;

FIG. 7 is a flowchart for explaining a user data reading process of the non-volatile memory device;

FIG. 8 is a flowchart for explaining a user data erasing process of the non-volatile memory device;

FIG. 9 is a flowchart for explaining an access inhibiting process of the non-volatile memory device;

FIG. 10 is a flowchart for explaining an access permitting process of the non-volatile memory device;

FIG. 11 is a flowchart for explaining a command processing count reading process of the non-volatile memory device;

FIG. 12 is a flowchart for explaining an access information reading process of the non-volatile memory device;

FIG. 13 is a schematic diagram illustrating an internal configuration of a system information storing area in accordance with another exemplary embodiment;

FIG. 14 is a schematic diagram illustrating an internal configuration of a system information storing area in accordance with still another exemplary embodiment; and

FIG. 15 is a schematic diagram illustrating a configuration of a non-volatile memory device in accordance with yet another exemplary embodiment.

### DETAILED DESCRIPTION

Hereinafter, exemplary embodiments will be described with reference to the accompanying drawings as appropriate. However, unnecessarily detailed description may occasionally be omitted. For example, detailed description of well-known matters and redundant description of substantially the same configuration may occasionally be omitted. This is to avoid the following description from becoming unnecessarily redundant, and to allow any person skilled in the art to easily understand the description.

Also, it should be noted that the following description and the accompanying drawings are provided to allow any person skilled in the art to fully understand the present disclosure, and that it is not intended to limit the subject matter described in the claims by the following description.

### First Exemplary Embodiment

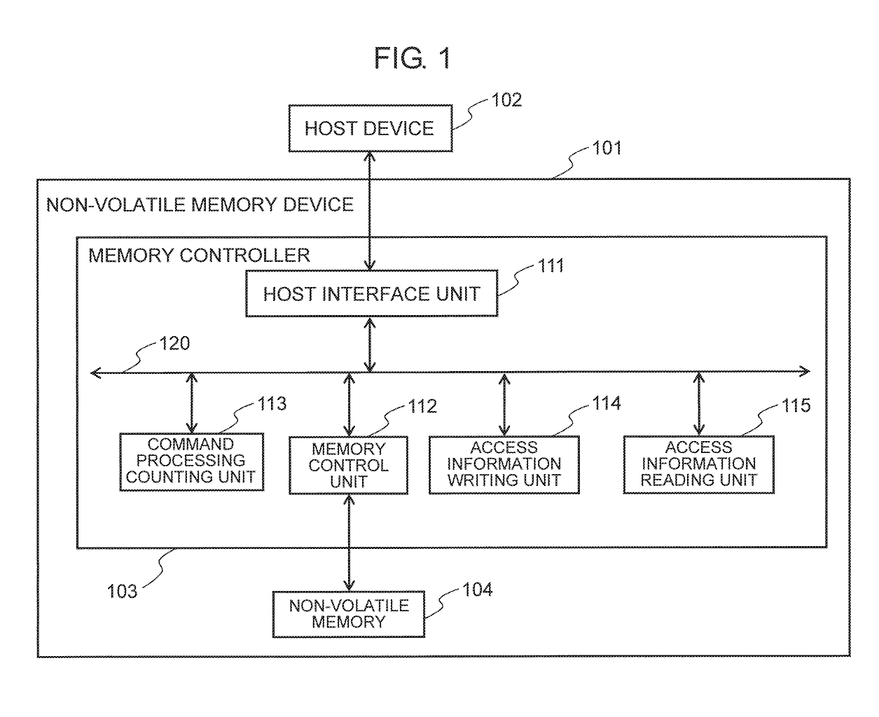

Hereinafter, a first exemplary embodiment will be described with reference to FIG. 1 to FIG. 12.

### 1-1. Configuration

### 1-1-1. Configuration of Memory Device

FIG. 1 is a schematic diagram illustrating a configuration of a non-volatile memory device in accordance with a first exemplary embodiment.

Non-volatile memory device 101 (an example of a non-volatile memory device) is a memory card, and includes memory controller 103 (an example of a memory controller), and non-volatile memory 104 (an example of a non-volatile memory). Non volatile memory device 101 is capable of storing digital data of contents (hereafter referred to as content data). Non-volatile memory 101 is connectable to host device 102.

Host device 102 (an example of an external device) is a device that records the content data in non-volatile memory device 101. Host device 102 may, for example, be a digital camera.

Memory controller 103 is configured by a semiconductor circuit that receives a command from host device 102, and controls writing of the content data into and reading of the control data from non-volatile memory 104. The semiconductor circuit may be configured such that specific functions are implemented by hardware only or implemented by hardware in cooperation with software (programs). For example, the semiconductor circuit may be configured by an ASIC (application specific integrated circuit), a FPGA (field programmable gate array), a CPU (central processing unit), an MPU (micro-processing unit), or a microcomputer.

Non-volatile memory 104 is a recording medium that is capable of holding the content data without a power source. For example, non-volatile memory 104 may be a NAND flash memory.

Memory controller 103 includes host interface unit 111, memory control unit 112, command processing counting unit 113 (an example of an access counting unit), access information writing unit 114 (an example of an access information writing unit), and access information reading unit 115. In the present exemplary embodiment, each unit of memory controller 103 is connected to another unit through bus 120.

Host interface unit 111 transmits content data to and receives content data from host device 102.

Memory control unit 112 controls writing of content data into, reading of content data from, and erasing of content data in non-volatile memory 104.

Command processing counting unit 113 counts, as a command processing count, the number of times transmissions and receptions of commands and content data have been performed between host interface unit 111 and host device 102.

Access information writing unit 114 writes information regarding an access (hereafter referred to as access information) into non-volatile memory 104. The access information includes, as described later, a command type, an access sector address, and an access sector size.

Access information reading unit 115 reads out the access information and the command processing count written in non-volatile memory 104, and transmits the readout data to host device 102.

### 1-1-2. Internal Configuration of Non-Volatile Memory 104

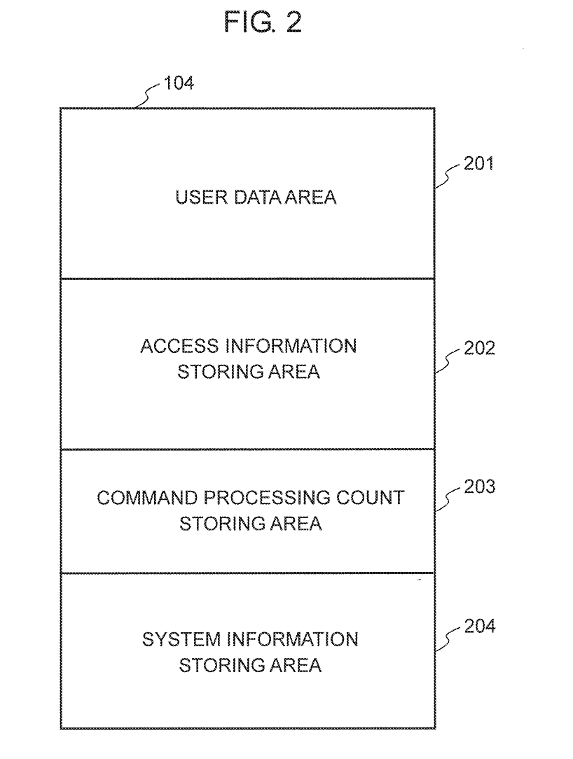

FIG. 2 is a schematic diagram illustrating an internal configuration of non-volatile memory 104. Non-volatile memory 104 has user data area 201 (an example of a user data area), access information storing area 202 (an example of an access information storing area), command processing count storing area 203, and system information storing area 204.

User data area 201 is an area for storing the content data transmitted from host device 102.

Access information storing area 202 is an area for storing the access information.

Command processing count storing area 203 is an area for storing the command processing count.

System information storing area 204 is an area for storing information regarding permission/inhibition of access to user data area 201.

### 1-1-3. Internal Configuration of Access Information Storing Area 202

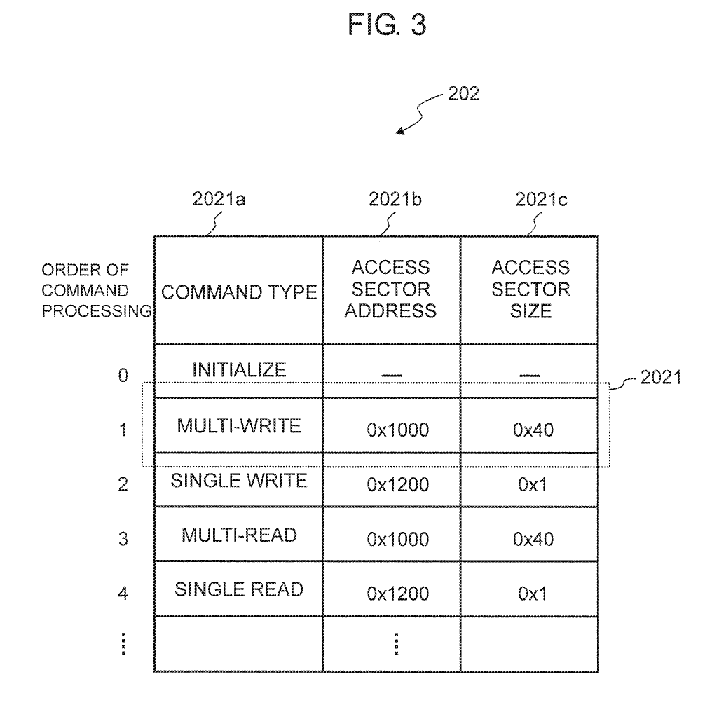

FIG. 3 is a schematic diagram illustrating an internal configuration of access information storing area 202. Access information storing area 202 is an area that is capable of storing, as access information 2021 (an example of access information), a plurality of sets of data each containing command type 2021a (an example of an access type), access sector address 2021b (an example of an address of data in the user data area), and access sector size 2021c (an example of a size of data). Pieces of access information 2021 are stored in the order the commands were processed.

Command type 2021a is information indicating a type of a command, and includes “initialize”, “single write”, “multi-write”, “single read”, “multi-read”, “single erase”, “multi-erase”, “inhibit access”, and “permit access”. The “initialize” command is a command to initialize non-volatile memory device 101. The “single write” command is a command to write data into one sector (one sector may, for example, be 512 bytes) in user data area 201. The “multi-write” command is a command to write data into a plurality of sectors in user data area 201. The “single read” command is a command to read data from one sector in user data area 201. The “multi-read” command is a command to read data from a plurality of sectors in user data area 201. The “single erase” command is a command to erase data of one sector in user data area 201. The “multi-erase” command is a command to erase data of a plurality of sectors in user data area 201. The “inhibit access” command is a command to inhibit access to user data area 201. The “permit access” command is a command to permit access to user data area 201.

Access sector address 2021b is a write address, a read address or an erase address of user data area 201. The access sector address is stored on a sector by sector basis.

Access sector size 2021c is a size of data written into user data area 201, a size of data read from user data area 201 or a size of data erased in user data area 201. The access sector size is stored on a sector by sector basis.

In a case of a command that is not associated with transfer of content data, the access sector address and the access sector size may not be stored.

### 1-1-4. Internal Configuration of System Information Storing Area 204

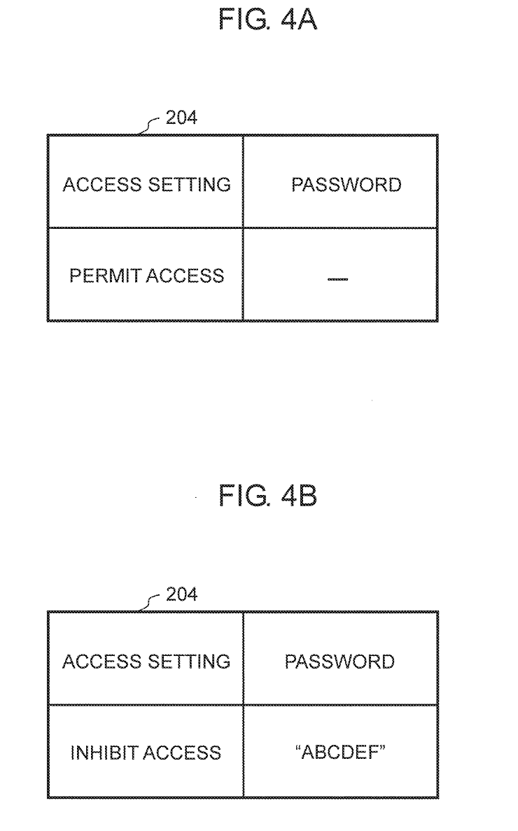

Each of FIG. 4A and FIG. 4B schematically illustrates an internal configuration of system information storing area 204. System information storing area 204 is an area that can store an access setting and a password. The access setting area is for storing information indicating a state whether access to the user data area is permitted or inhibited. The password area is an area for storing a character string that is necessary to change the setting of access to the user data area from the inhibited state to the permitted state. FIG. 4A illustrates a state of system information storing area 204 when access to user data area 201 is inhibited. On the other hand, FIG. 4B illustrates a state of system information storing area 204 when access to user data area 201 is inhibited.

### 1-2. Operations

Operations of non-volatile memory device 101 configured as above will hereinafter be described.

Non-volatile memory device 101 performs each operation of an initializing process, a user data writing process, a user data reading process, a user data erasing process, an access inhibiting process, an access permitting process, a command processing count reading process, and an access information reading process. The initializing process is a process to allow non-volatile memory device 101 to be supplied with power, and to be capable of transmitting and receiving commands and content data. The user data writing process is a process to write a content data into user data area 201. The user data reading process is a process to read a content data from user data area 201. The user data erasing process is a process to erase a content data in user data area 201. The access inhibiting process is a process to inhibit access to user data area 201. The access permitting process is a process to permit access to user data area 201. The command processing count reading process is a process to read a command processing count from command processing count storing area 203. The access information reading process is a process to read access information from access information storing area 202.

Each of the above operations will be described hereinafter.

### 1-2-1. Initializing Process

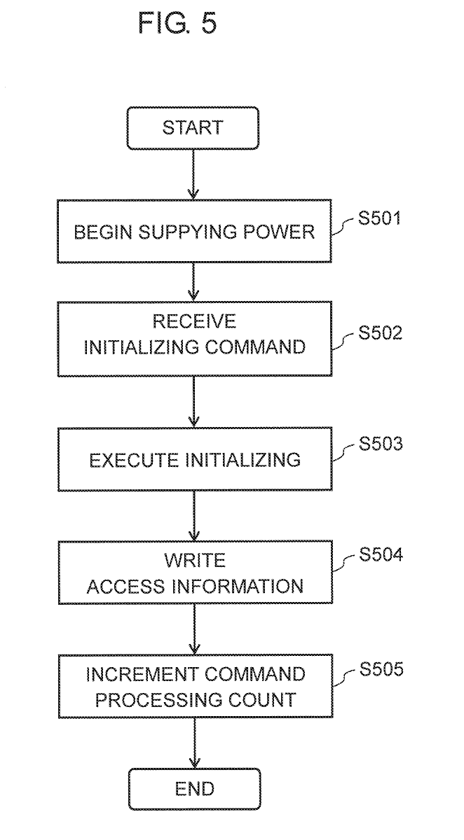

FIG. 5 is a flowchart for explaining an initializing process of non-volatile memory device 101.

Once non-volatile memory device 101 is connected to host device 102, non-volatile memory device 101 is supplied with power from host device 102 (S501).

Next, host device 102 transmits an initializing command, and host interface unit 111 receives the initializing command (S502).

Memory control unit 112 performs initial settings such, for example, as resetting of the semiconductor circuit that controls non-volatile memory 104 (S503).

Next, access information writing unit 114 writes access information including a command type set to the “initialize” into access information storing area 202 (S504). The writing destination address of the access information is an address obtained by multiplying the command processing count stored in command processing count storing area 203 by a size of the access information. This allows the access information to be stored in access information storing area 202 in the order the command was processed.

Finally, command processing counting unit 113 increments the command processing count stored in command processing count storing area 203 by one, and ends the initializing process (S505).

### 1-2-2. User Data Writing Process

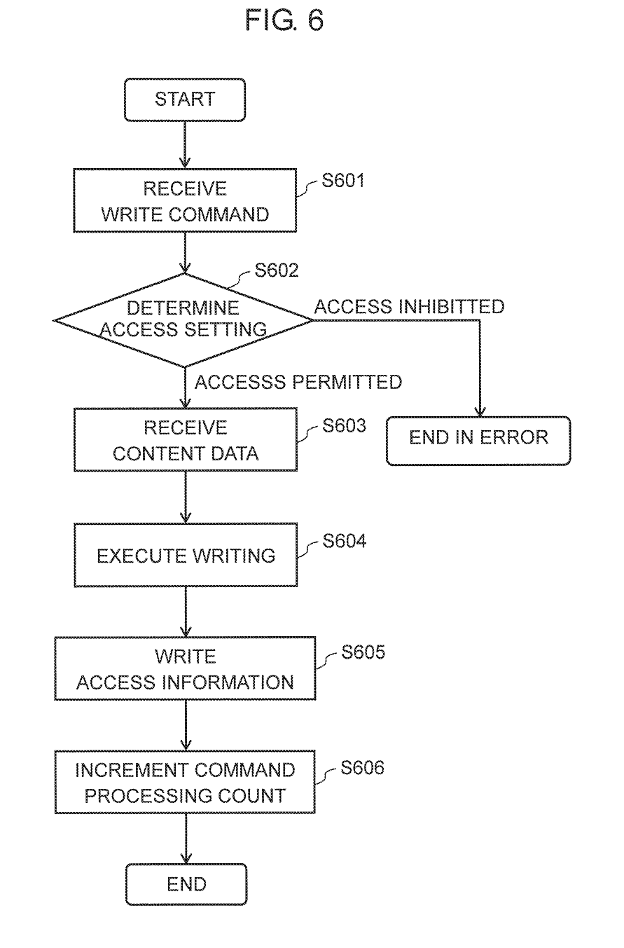

FIG. 6 is a flowchart for explaining a user data writing process of non-volatile memory device 101.

In a case where host device 102 writes a content data into user data area 201, host device 102 transmits a write command and a write address to non-volatile memory device 101. Host interface unit 111 of non-volatile memory device 101 receives the write command and the write address transmitted from host device 102 (S601). The command type of the write command is either the “single write” for writing data into one sector in user data area 201 or the “multi-write” for writing data into a plurality of sectors in user data area 201.

Next, memory control unit 112 reads the access setting stored in system information storing area 204, and determines whether user data area 201 is in the access permitted state or the access inhibited state (S602). In a case of the access inhibited state, memory control unit 112 informs host device 102 of an occurrence of an error, and ends the user data writing process. In a case of the access permitted state, the process proceeds to step S603.

Host device 102 transmits a content data, which is a data to be written, and host interface unit 111 receives the content data (S603).

Memory control unit 112 writes the content data into the write address in user data area 201a received in step S601 (S604).

Access information writing unit 114 writes access information into access information storing area 202 (S605). This access information includes the command type of the write command received in step S601, the write address received in step S601, and the write data size of the content data received in step S603. The write address of the access information is, similarly to step S504 in FIG. 5, an address obtained by multiplying a command processing count stored in command processing count storing area 203 by a size of the access information.

Finally, command processing counting unit 113 increments the command processing count stored in command processing count storing area 203 by one (S606), before the user data writing process ends.

### 1-2-3. User Data Reading Process

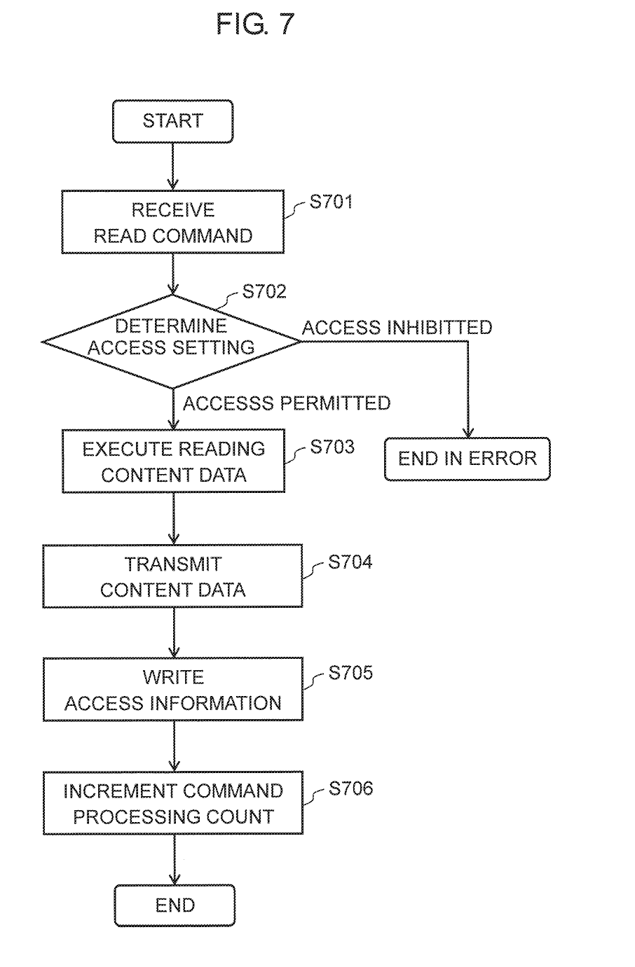

FIG. 7 is a flowchart for explaining a user data reading process of non-volatile memory device 101.

In a case where host device 102 reads a content data from user data area 201, host device 102 transmits a read command and a read address to non-volatile memory device 101. Host interface unit 111 of non-volatile memory device 101 receives the read command and the read address transmitted from host device 102 (S701). The command type of the read command is the “single read” for reading data from one sector of user data area 201 or the “multi-read” for reading data from a plurality of sectors of user data area 201.

Next, memory control unit 112 reads the access setting of system information storing area 204, and determines whether user data area 201 is in the access permitted state or the access inhibited state (S702). In a case of the access inhibited state, memory control unit 112 informs host device 102 of an occurrence of an error, and ends the user data reading process. In a case of the access permitted state, the process proceeds to S703.

Memory control unit 112 reads, as a readout data, a content data from the read address in user data area 201 received in step S701 (S703).

Host interface unit 111 transmits the content data read in step S703 to host device 102 (S704). Host device 102 receives the content data.

Access information writing unit 114 writes access information into access information storing area 202 (S705). This access information includes the command type of the read command received in step S701, the read address received in step S701, and the readout data size of the content data transmitted to host device 102 in step S704. The write address of the access information is, similarly to step S504 of FIG. 5, an address obtained by multiplying the command processing count stored in command processing count storing area 203 by a size of the access information.

Finally, command processing counting unit 113 increments the command processing count stored in command processing count storing area 203 by one (S706), before the user data reading process ends.

### 1-2-4. User Data Erasing Process

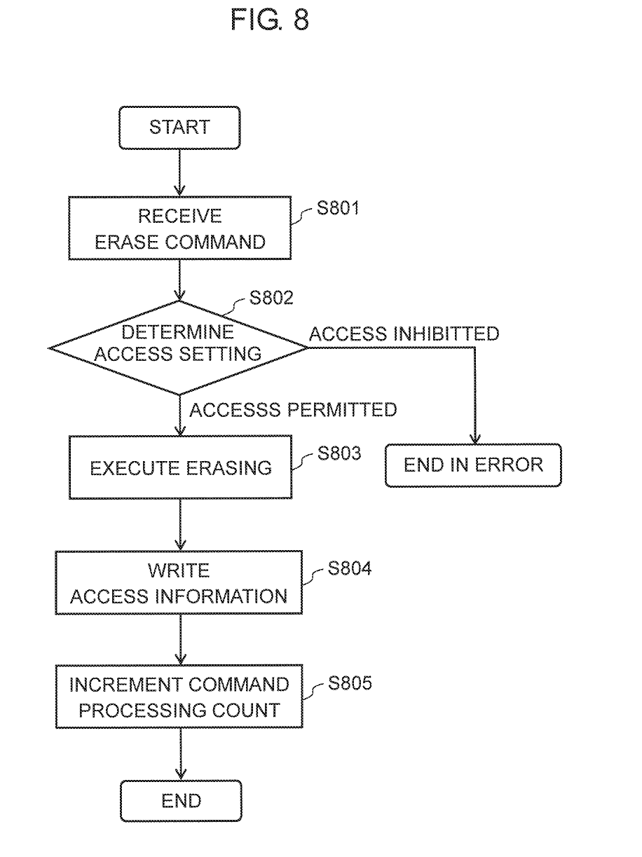

FIG. 8 is a flowchart for explaining a user data erasing process of non-volatile memory device 101.

In a case where host device 102 erases a content data written in user data area 201, host device 102 transmits an erase command, an erase address and an erase data size to non-volatile memory device 101. Host interface unit 111 of non-volatile memory device 101 receives the erase command, the erase address and the erase data size transmitted from host device 102 (S801). The command type of the erase command is the “single erase” for erasing data in one sector of user data area 201 or the “multi-erase” for erasing data in a plurality of sectors of user data area 201.

Next, memory control unit 112 reads the access setting of system information storing area 204, and determines whether user data area 201 is in the access permitted state or the access inhibited state (S802). In a case of the access inhibited state, memory control unit 112 informs host device 102 of an occurrence of an error, and ends the user data erasing process. In a case of the access permitted state, the process proceeds to S803.

Memory control unit 112 erases content data in an area of user data area 201 specified by the erase address and the erase size received in step S801 (S803).

Access information writing unit 114 writes access information into access information storing area 202 (S804). This access information includes the command type of the erase command received in step S801, the erase address and the erase data size received in step S801. The write address of the access information is, similarly to step S504 of FIG. 5, an address obtained by multiplying the command processing count stored in command processing count storing area 203 by a size of the access information.

Finally, command processing counting unit 113 increments the command processing count stored in command processing count storing area 203 by one (S805), before the user data erasing process ends.

### 1-2-5. Access Inhibiting Process

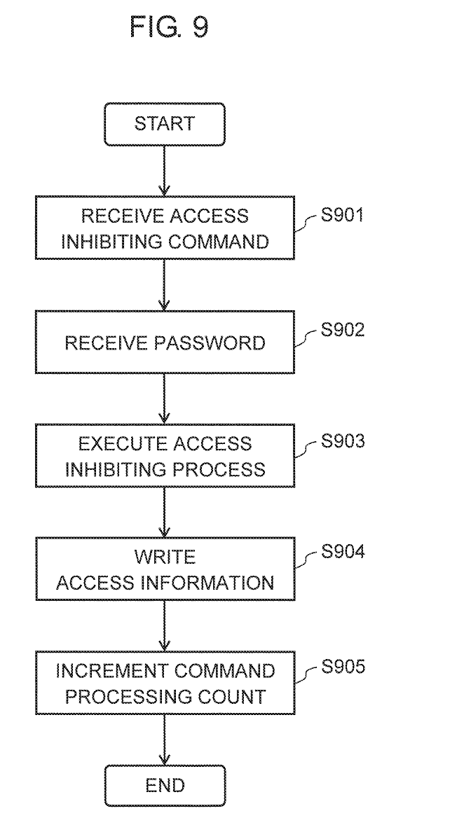

FIG. 9 is a flowchart for explaining an access inhibiting process of non-volatile memory device 101.

In a case where host device 102 inhibits access to user data area 201, host device 102 transmits an access inhibiting command to non-volatile memory device 101. Host interface unit 111 of non-volatile memory device 101 receives the access inhibiting command transmitted from host device 102 (S901). The command type of the access inhibiting command is the “inhibit access” for inhibiting access to user data area 201.

Next, host device 102 transmits a password to non-volatile memory device 101, and host interface unit 111 receives the password (S902). The password will be used to permit access in the access permitting process.

Memory control unit 112 writes the received password into system information storing area 204, and changes the access setting in system information storing area 204 to the “inhibit access” (S903). By this process, system information storing area 204 becomes the state as shown in FIG. 4B.

Access information writing unit 114 writes access information into access information storing area 202 (S904). This access information is the command type of the access inhibiting command received in step S901. The write address of the access information is, similarly to step S504 of FIG. 5, an address obtained by multiplying the command processing count stored in command processing count storing area 203 by a size of the access information.

Finally, command processing counting unit 113 increments the command processing count stored in command processing count storing area 203 by one (S905), before the access inhibiting process ends.

If either the user data writing process, the user data reading process or the user data erasing process is started after the access setting has been changed to the “inhibit access” by the above-described access inhibiting process, memory control unit 112 does not execute an access to the user data area, informs host device 102 of an occurrence of an error, and ends the started process. Accordingly, access to the user data can be inhibited by the above-described access inhibiting process.

### 1-2-6. Access Permitting Process

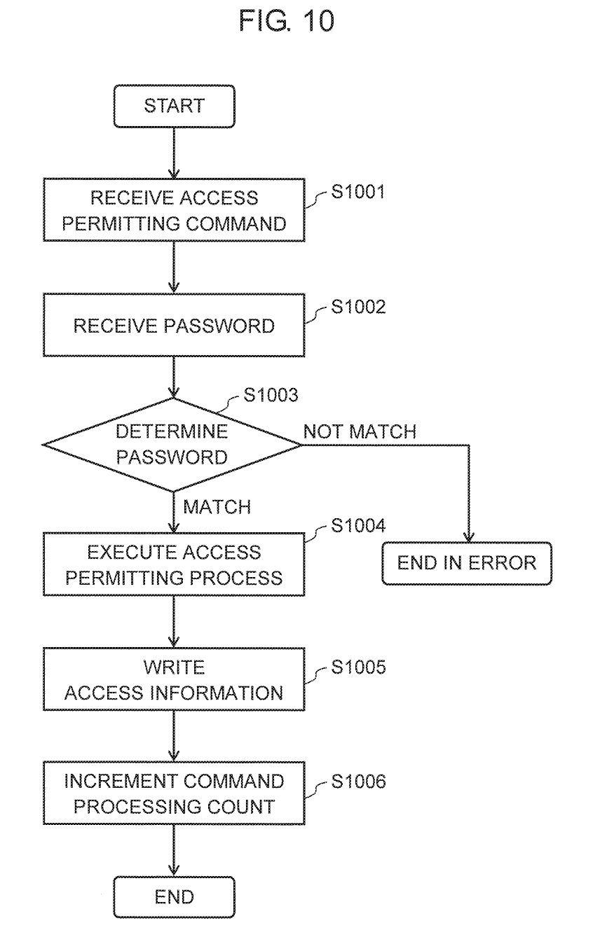

FIG. 10 is a flowchart for explaining an access permitting process of non-volatile memory device 101.

In a case where host device 102 permits access to user data area 201, host device 102 transmits an access permitting command to non-volatile memory device 101. Host interface unit 111 of non-volatile memory device 101 receives the access permitting command transmitted from host device 102 (S1001). The command type of the access permitting command is the “permit access” for permitting access to user data area 201.

Next, host device 102 transmits a password to non-volatile memory device 101, and host interface unit 111 receives the password (S1002).

Memory control unit 112 reads a password from system information storing area 204, and determines if the readout password matches the password received in step S1002 (S1003). In a case where the passwords do not match, memory control unit 112 informs host device 102 of an occurrence of an error, and ends the access permitting process. In a case where the passwords match, the process proceeds to S1004.

Memory control unit 112 erases the password in system information storing area 204, and changes the access setting in system information storing area 204 to the “permit access” (S1004). By this process, system information storing area 204 becomes the state as shown in FIG. 4A.

Access information writing unit 114 writes access information into access information storing area 202 (S1005). This access information is the command type of the access permitting command received in step S1001. The write address of the access information is, similarly to step S504 of FIG. 5, an address obtained by multiplying the command processing count stored in command processing count storing area 203 by a size of the access information.

Finally, command processing counting unit 113 increments the command processing count stored in command processing count storing area 203 by one (S1006), before the access permitting process ends.

After the access setting has been changed to the “inhibit access” by the access inhibiting process, the access setting is changed to the “permit access” by the above-described access permitting process. After this change of the access setting, either the user data writing process, the user data reading process or the user data erasing process can be started in the condition that access to the user data area is possible. Accordingly, access to the user data can be permitted by the above-described access permitting process.

### 1-2-7. Command Processing Count Reading Process

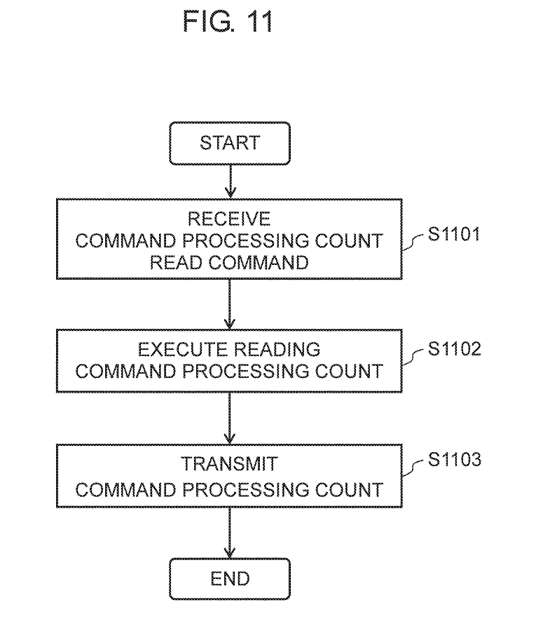

FIG. 11 is a flowchart for explaining a command processing count reading process of non-volatile memory device 101.

In a case where host device 102 reads a command processing count from command processing count storing area 203, host device 102 transmits a command processing count read command to non-volatile memory device 101. Host interface unit 111 of non-volatile memory device 101 receives the command processing count read command transmitted from host device 102 (S1101).

Next, access information reading unit 115 reads the command processing count from command processing count storing area 203 (S1102).

Host interface unit 111 transmits the command processing count to host device 102, and host device 102 receives the command processing count (S1103), before the command processing count reading process ends.

### 1-2-8. Access Information Reading Process

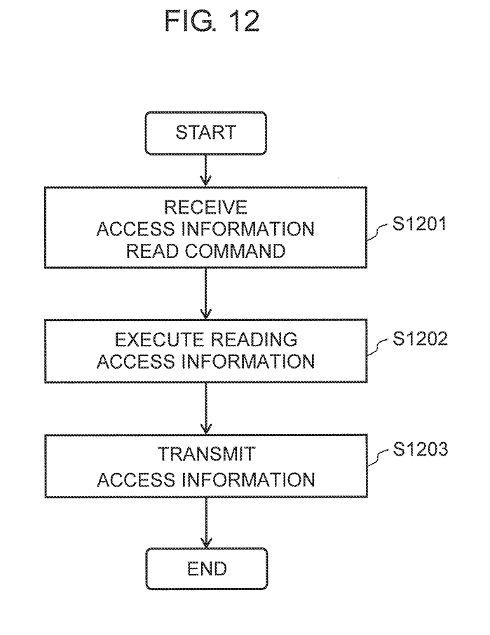

FIG. 12 is a flowchart for explaining an access information reading process of non-volatile memory device 101.

In a case where host device 102 reads access information from access information storing area 202, host device 102 transmits an access information read command and a read address to non-volatile memory device 101. Host interface unit 111 of non-volatile memory device 101 receives the access information read command and the read address transmitted from host device 102 (S1201).

Next, access information reading unit 115 reads access information from the read address in access information storing area 202 (S1202).

Host interface unit 111 transmits the access information to host device 102, and host device 102 receives the access information (S1103), before the access information reading process ends.

### 1-3. Advantageous Effects

As described hereinabove, in the present exemplary embodiment, non-volatile memory device 101 (an example of a non-volatile memory device) is connectable to host device 102 (an example of an external device), and includes non-volatile memory 104 (an example of a non-volatile memory), and memory controller 103 (an example of a memory controller). Non-volatile memory 104 has user data area 201 (an example of a user data area) in which data can be written or from which data can be read according to an access by host device 102, and access information storing area 202 (an example of an access information storing area) in which access information indicating the access is stored. Memory controller 103 is connected to non-volatile memory 104, and includes access information writing unit 114 that is responsive to each occurrence of access information to store the access information into access information storing area 202. Access information 2021 (an example of access information) includes: command type 2021a (an example of an access type) including at least writing of the data, reading of the data, erasing of the data, and initialization of the memory controller; access sector address 2021b (an example of an address of data in the user data area); and access sector size 2021c (an example of a size of data). Access information writing unit 114 stores the access information in access information storing area 202 so that an order of a process executed by the memory controller according to the access can be obtained.

In the conventional non-volatile memory devices, in which commands from the host device are analyzed and recorded, it is not possible to know the number of times data have been actually written into the non-volatile memory. For example, when data are written into a non-volatile memory by a page unit of 4 KB (1 KB=1024 bytes), there may be two possible cases. In one case, data are written in a certain address range A of 4 KB plural times, and then data are written in another address range B of 4 KB plural times (referred to as Case 1). In the other case, data are written in address range A and address range B alternately (referred to as Case 2). In Case 1, it is possible to temporality store the write data in a volatile memory of 4 KB, and write the data in a NAND flash memory collectively by a page unit. Therefore, the number of times to write data in the NAND flash memory can be reduced. In Case 2, on the other hand, the 4 KB volatile memory cannot store all of the write data, so that it is necessary to write data sequentially in the NAND flash memory. Therefore, the number of times to write data in the NAND flash memory in Case 2 becomes larger compared to Case 1.

Non-volatile memory device 101 in accordance with the present exemplary embodiment can obtain not only the access type (command type), but also the sequential order of access (command). Accordingly, in either of Case 1 and Case 2 as described above, for example, it is possible to accurately measure the history of accesses to the non-volatile memory. Also, non-volatile memory device 101 in accordance with the present exemplary embodiment can be realized without adding a particular interface for connection with host device 102.

Further, in non-volatile memory device 101 in accordance with the present exemplary embodiment, memory controller 103 includes host interface unit 111, memory control unit 112, command processing counting unit 113 (an example of an access counting unit), access information writing unit 114, and access information reading unit 115. Also, non-volatile memory 104 has user data area 201, access information storing area 202, command processing count storing area 203, and system information storing area 204.

When each of commands for accessing user data area 201 is processed, the command type, the access sector address and the access sector size, which are included in access information related to the command, are stored in access information storing area 202 in the order the command is processed. The access information stored in access information storing area 202 can be read by the access information reading process.

Further, after host device 102 transmits a plurality of commands for accessing user data area 201 to non-volatile memory device 101, host device 102 can extract the command type, the access sector address and the access sector size of each of the transmitted commands in the order the commands were processed. Accordingly, the order of accesses to user data can be obtained.

Further, in the present exemplary embodiment, non-volatile memory device 101 can obtain the command processing count by the command processing count reading process. The size of access information having been recorded can be calculated by multiplying the command processing count by the size of the access information.

Further, host device 102 can secure an adequate capacity of buffer memory for storing the access information having been recorded before performing the access information reading process. Accordingly, it is not necessary to secure an additional buffer memory during the access information reading process, so that high speed reading of the access information is possible.

Further, in the present exemplary embodiment, access information is stored in access information storing area 202 even when the access inhibiting process is performed and when the access permitting process is performed. The access information stored in access information storing area 202 can be read by the access information reading process.

In the present exemplary embodiment, non-volatile memory device 101 can obtain the access information even in a case of a command (e.g., a command for storing or erasing of a password) which does not perform writing, reading or erasing of the user data. Accordingly, it is possible to obtain more accurate information regarding access to non-volatile memory 104.

### Other Exemplary Embodiments

The first exemplary embodiment has been described hereinbefore as an example of technique disclosed in the present application. However, the technique in accordance with the present disclosure is not limited to that described above, and is applicable to other exemplary embodiments that may be realized by making any modifications, changes, substitutions, additions or deletions. Also, structural components described in the above-described first exemplary embodiment may be combined so as to configure a new exemplary embodiment.

Some of such other exemplary embodiments will be shown hereinafter.

(1) In the first exemplary embodiment, an example of an internal configuration of access information storing area 202 has been described with reference to FIG. 3. However, the internal configuration of access information storing area 202 may be such that the order of command processing can be determined, and is not limited to the configuration shown in FIG. 3. The order of command processing itself may be stored as the access information instead of storing access information of each command processing in the order of command processing.

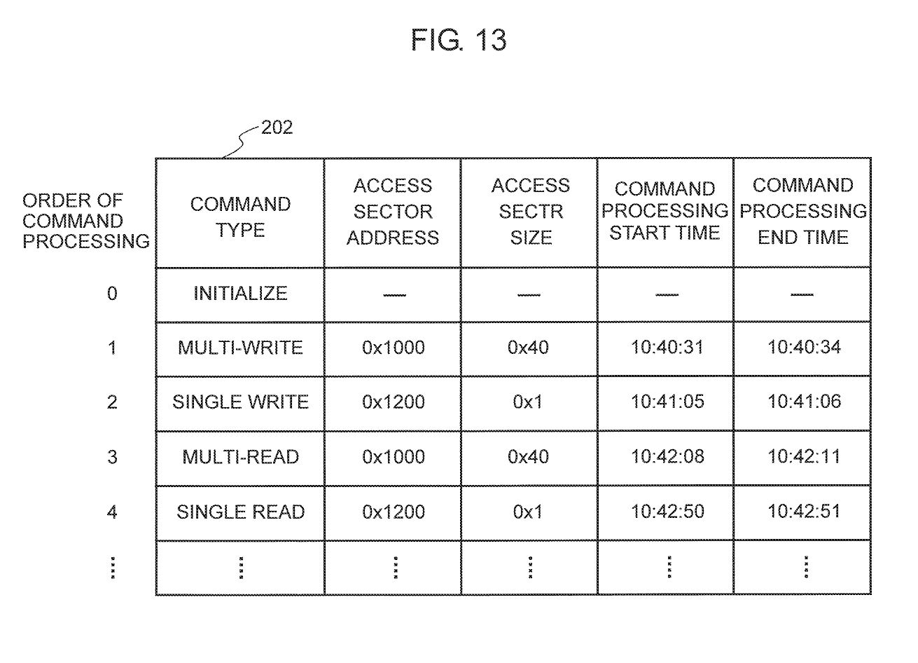

(2) The access information may include a command processing start time and a command processing end time as shown in FIG. 13. The command processing start time is a time at which host interface unit 111 receives a command. The command processing end time is a time at which access information is written in access information storing area 202. By obtaining the command processing start time and the command processing end time, it is possible to calculate a time period during which non-volatile memory device 101 is executing a command processing. This makes it possible to efficiently estimate a current consumption or the like of non-volatile memory device 101 associated with the command processing.

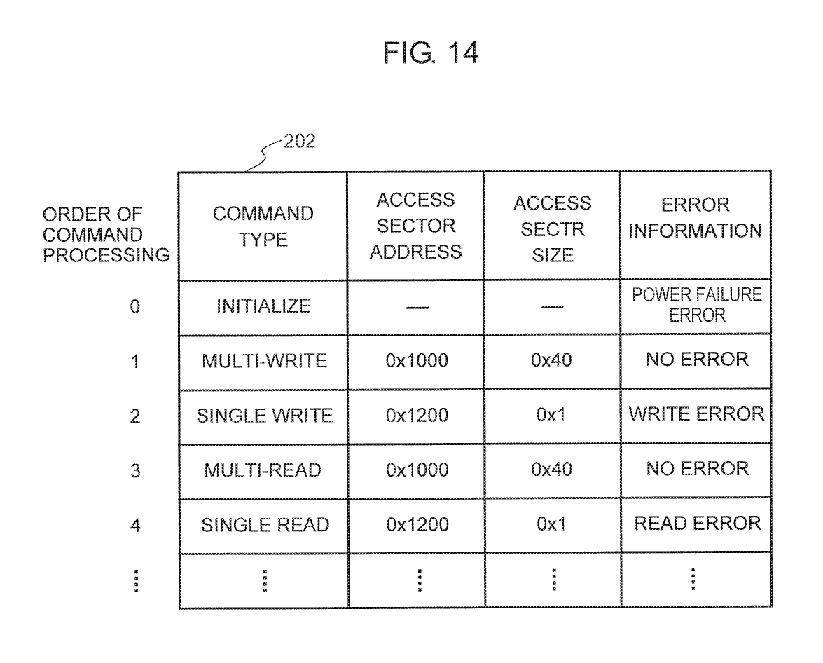

(3) The access information may include error information of each command as shown in FIG. 14. By obtaining the error information, it is possible to obtain an error occurrence history of non-volatile memory device 101 from host device 102. The error occurrence history is useful to determine in an early stage that non-volatile memory device 101 is close to the end of its life.

(4) The access sector address and the access sector size, which are included in the access information, may be able to indicate the address and the size of the area to be accessed, and may not be the address and size in sector unit. For example, the address and size may be the address and size in byte unit.

(5) In the first exemplary embodiment, an example of system information storing area 204 has been described with reference to FIG. 4A and FIG. 4B. In FIG. 4A and FIG. 4B, there is one kind of access setting, and permission and inhibition of all of writing, reading and erasing are administrated by the access setting shown in FIG. 4A and FIG. 4B. Instead of this manner, permission and inhibition of each of writing, reading and erasing may be administrated separately. For example, the access setting for permitting and inhibiting writing and erasing may be administrated separately from the access setting for permitting and inhibiting reading, to realize non-volatile memory device 101 that allows inhibition of only writing and erasing. This configuration is useful to satisfy, for example, such a security requirement that permits viewing an image while preventing the image from being tampered or altered. In this case also, it is effective for obtaining an accurate history of accesses to non-volatile memory 104 to store, as the access information, the information regarding permission and inhibition in access information storing area 202.

(6) In each of the command processing count reading process and the access information reading process in accordance with the first exemplary embodiment, the command processing count or the access information is transmitted to host device 102 regardless of the state of the access setting in system information storing area 204. However, the manner of processing is not limited to this manner. When the access setting is the “inhibit access”, the process may be ended after informing host device 102 of an error, without transmitting the command processing count or the access information. With this manner, host device 102 that does not have a password will not be able to obtain the command processing count and the access information from non-volatile memory device 101, so that the confidentiality of the access information can be enhanced.

(7) It has been described in the first exemplary embodiment that the process of writing access information in access information storing area 202 includes the initializing process, user data writing process, user data reading process, user data erasing process, access inhibiting process, and access permitting process. However, access information may be written in other processes. For example, access information may be written in access information storing area 202 in the command processing count reading process and the access information reading process. In other words, the access information stored in access information storing area 202 may further include information regarding an access for reading access information from access information storing area 202. Also, the access information stored in access information storing area 202 may further include information regarding an access for reading the command processing count, or the number of accesses, from access information storing area 202. It is effective for obtaining accurate history of access to non-volatile memory 104 to obtain the order of processing of the command processing count reading process and the access information reading process.

(8) If non-volatile memory device 101 is capable of performing a process of changing the clock and voltage for connecting host device 102 and host interface unit 111 and a process of obtaining a state of non-volatile memory device 101, access information of these processes also may be written in access information storing area 202. The access information of these processes is useful to determine whether or not host device 102 is operating normally.

(9) It has been described in the first exemplary embodiment that the command of the command type “multi-write” is a command for writing data in a plurality of sectors of user data area 201. The “multi-write” command may be a command that allows writing data in a plurality of sectors of user data area 201, and may allow writing data in a single sector. Similarly, the “multi-read” command may allow reading data from a single sector of user data area 201. Also, the “multi-erase” command may allow erasing data in a single sector of user data area 201.

(10) In the first exemplary embodiment, the access setting stored in system information storing area 204 is read in each of the user data writing process, the user data reading process and the user data erasing process. However, reading of the access setting may not be necessary if an access setting can be confirmed in each of these processes. For example, the access setting may be read in the initializing process from system information storing area 204 and stored in a volatile memory that can be accessed more quickly than the non-volatile memory, and the access setting stored in the volatile memory may be referred to in each of the user data writing process, the user data reading process and the user data erasing process. This is effective to increase the processing speed.

(11) Although the user data and the access information are stored in the same non-volatile memory 104 in the first exemplary embodiment, they may be stored in separate non-volatile memories from each other. This is effective to avoid degradation of non-volatile memory 104 having stored therein user data due to writing of access information.

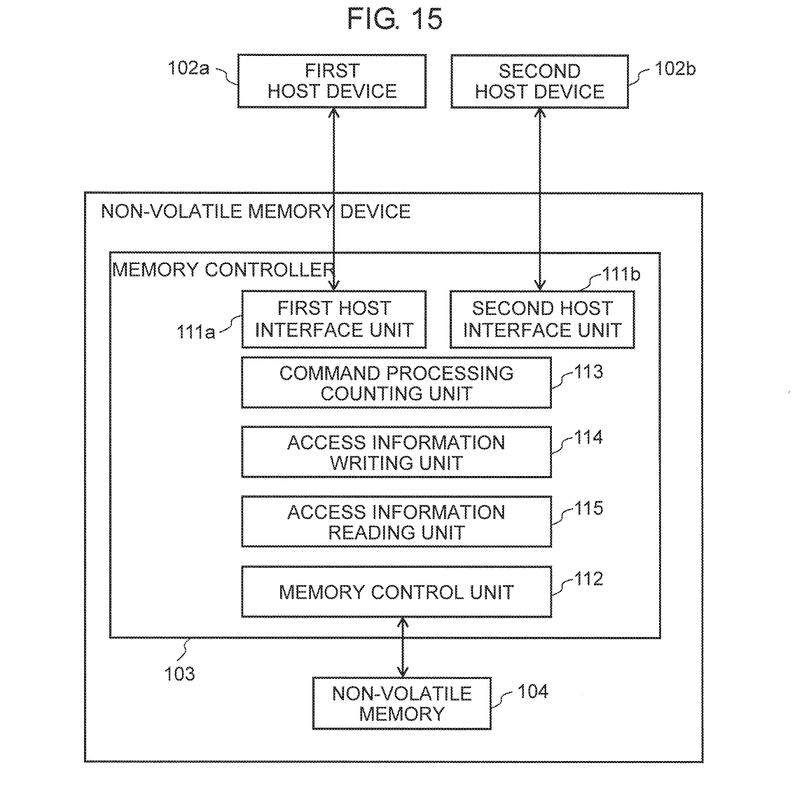

(12) Non-volatile memory device 101 in the first exemplary embodiment is configured such that only host device 102 can read the access information. However, non-volatile memory device 101 may be configured, as shown in FIG. 15, so as to be connectable to two host devices (first host device 102a and second host device 102b), and to be provided, in addition to first host interface unit 11a which is connectable to first host device 102a, with second host interface unit 111b which is connectable to second host interface 102b so that the access information can be read by second host device 102b. There is a case that non-volatile memory device 101 is adhered to first host device 102a so as to be difficult to be disconnected from first host device 102a, and that first host device 102a does not have the function of reading the access information. Even in this case, the access information can be easily obtained by connecting non-volatile memory device 101 to second host device 102 which has the function of obtaining the access information.

Also, second host device 102b connected to second host interface unit 111b may be permitted only to read the access information, and may be inhibited to access user data area 201 of non-volatile memory 104. By preventing access to user data area 201 by other host devices than host device 102, confidentiality of user data area 201 can be enhanced.

Non-volatile memory device 101 may be provided with three or more host interface units so as to be connectable to three or more host devices.

(13) Functional blocks in non-volatile memory device 101 shown in FIG. 1 may be either individually integrated on separate chips from one another or may be collectively integrated so as to be partially or entirely mounted on a single chip. A part or all of the processes performed in each block of non-volatile memory device 101 may be realized by one or more programs. A part or all of the processes in each functional block in the above-described exemplary embodiments are performed with a central processing unit (CPU) in a computer. Also, program for performing respective processes are stored in a storage device such, for example, as a hard disk or a read-only memory (ROM), and executed in the ROM or after being read into a random access memory (RAM).

Also, each process in the exemplary embodiments may be implemented either by hardware or software including such software that is realized in cooperation with an operating system (OS), middleware or specific libraries. Further, each process may be implemented by a combination of both hardware and software.

(14) The order of execution of the processes in the exemplary embodiments may not necessarily be limited to the above-described order, and may be changed without departing from the spirit and scope of the present invention.

The present disclosure is applicable to non-volatile memory devices, or more specifically to memory cards, flash drives, embedded memory devices, solid state drives (SSDs), and the like.

What is claimed is:

1. A non-volatile memory device connectable to an external device, the non-volatile memory device comprising:
a non-volatile memory that has: a user data area, writing data into and reading the data from the user data area being possible according to an access by the external device; and an access information storing area for storing access information indicating the access; and
a memory controller that is connected to the non-volatile memory, and includes an access information writing unit that stores the access information in the access information storing area on an occurrence of the access,
wherein the access information includes: an access type including at least writing of the data, reading of the data, erasing of the data, and initialization of the memory controller; an address of the data in the user data area; and a size of the data, and
wherein the access information writing unit stores the access information in the access information storing area so that an order of a process executed by the memory controller according to the access can be obtained.

2. The non-volatile memory device according to claim 1, wherein the memory controller transmits access information stored in the access information storing area to the external device according to a command from the external device.

3. The non-volatile memory device according to claim 1, wherein the memory controller further includes an access counting unit that counts a number of accesses by the external device, and stores the counted number of accesses in the access information storing area, and
wherein the access information writing unit obtains a second address that is obtained by multiplying the number of accesses by a size of the access information, and stores the access information in the second address.

4. The non-volatile memory device according to claim 1, wherein the access type further includes a setting of a limitation on accesses to the user data area of the non-volatile memory.

5. The non-volatile memory device according to claim 1, wherein the access type further includes information regarding whether writing of the data is a single write or a multi-write, or whether reading of the data is a single read or a multi-read.

6. The non-volatile memory device according to claim 1, wherein the access information further includes a start time and an end time of a process by the memory controller for each access.

7. The non-volatile memory device according to claim 1, wherein the access information further includes presence or absence of an error with respect to the access.

8. The non-volatile memory device according to claim 1, wherein the access information further includes other access information read from the access information storing area.

9. The non-volatile memory device according to claim 1, wherein the memory controller further includes an access counting unit that counts a number of accesses by the external device and then stores the counted number of accesses in the access information storing area, and
wherein the access information further includes information of reading the number of accesses from the access information storing area.

10. The non-volatile memory device according to claim 1, further comprising a plurality of external device interface units that are connectable to a plurality of external devices,
wherein the memory controller transmits the access information to only one of the external devices according to a command from the one of the external devices.
